(19) United States
(12) Patent Application Publication
(10) Pub. No.: US 2013/0026081 A1
(43) Pub. Date: Jan. 31, 2013

(54) PROCESS FOR THE PRODUCTION OF ECOLOGICAL PELLETS BY MEANS OF A CONTROL CHAMBER PLACED IN PRODUCTION PLANTS AND PELLET BAGGING

(71) Applicants: Valentino Rizzuto, Corciano (IT); Federico Ragnoni, Perugia (IT); Giuliano Ragnoni, Perugia (IT); Ruben Rizzuto, Corciano (IT)

(72) Inventors: Valentino Rizzuto, Corciano (IT); Federico Ragnoni, Perugia (IT); Giuliano Ragnoni, Perugia (IT); Ruben Rizzuto, Corciano (IT)

(73) Assignee: ECO PELLET GROUP S.R.L., Corciano (IT)

(21) Appl. No.: 13/519,585

(22) PCT Filed: Dec. 16, 2010
(86) PCT No.: PCT/IT2010/000502

§ 371 Date: Oct. 14, 2012

(30) Foreign Application Priority Data
Dec. 29, 2009 (IT) PG2009A000070

(51) Int. Cl. B27N 3/18; B07C 5/00; C10L 5/44

(52) U.S. Cl. 209/555

(57) ABSTRACT

Inventive process consisting of the inserting in any industrial PELLET production plant and at any point of the same plant of a technological system called a “control chamber” that can evaluate the biomass that will form the pellets, detecting the presence of toxic materials deriving from processing scrap and waste, with the presence of substances such as lacquers, paints, and sprays, or wood coming from trees contaminated by radioactive, toxic or other environmental factors. The “control chamber” consists of a pellet transport system, a series of sensors, optical devices, weighing and control systems that can continuously monitor, analyze and grade all the pellets. It also has a system for the selecting and storage of pellets according to the quality detected.

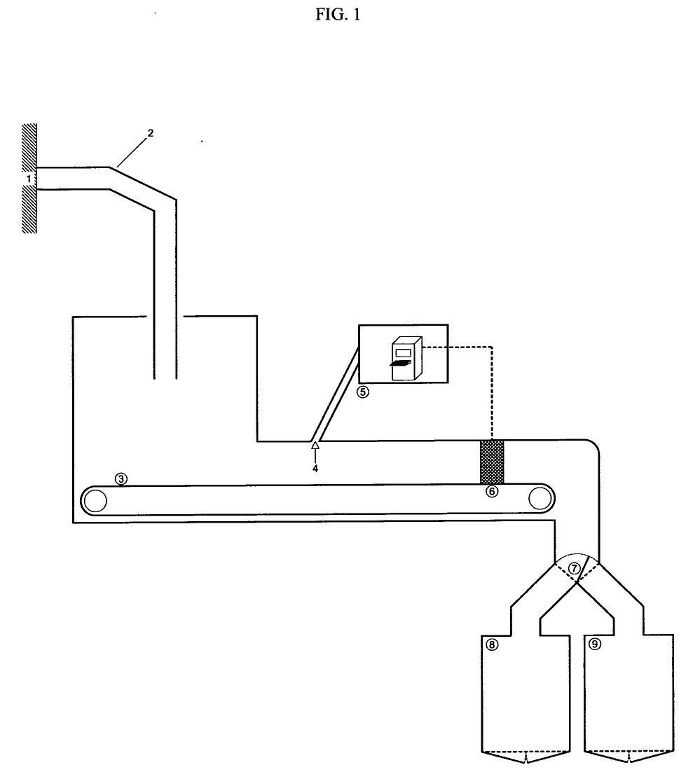

### TECHNICAL FIELD

This invention regards a special process for the production of ecological pellets by means of a specific control chamber to be placed in production plants and pellet bagging that makes it possible to reliably certify the ecological quality of the final product.

BACKGROUND ART

No process like this one is found in the current state of the art. The only method used until now is that of taking samples of pellets to be sent to the competent analysis institutes to check their parameters.

The analysis of these samples provides the data that become the reference for the entire production of the pellet plant that produced these samples.

But this does not mean that all the material produced before or after is equal or similar to the sample.

Indeed, the analysis of this sample provides data that become the reference for the entire production of the pellet plant that produced these samples.

Given that the wood in the pellet is a living material that has variations within it, the sample described above does not at all prove that all of the production of that plant corresponds to the sample analyzed.

Indeed, the taking of samples automatically excludes the monitoring of the entire production batch. Therefore, with the taking of samples, it is not possible to constantly monitor that among the biomass that will form the pellets there will not be toxic materials deriving from processing scrap and waste, with the presence of substances such as lacquers, paints, and sprays, or that there are no trees that were contaminated by radioactive, toxic or other environmental factors.

A previous Italian patent application filed on 29 May 2005 under no. PG2005A0019 and the holder of which is the applicant, as shown by application for registration of merger N. AR2009E000010 dated 7 Sep. 2009, emphasized the need to equip a special plant for pellet production, as described in PG2005A0019, with a control chamber that analyzed pellet samples on the spot and not at outside laboratories. It followed that the pellet sample analyzed by the control chamber determined the rejection or the acceptance of the entire batch of pellets from which the sample analyzed was taken.

Therefore the applicant set out to solve, with this invention, four very important problems not present in the state of the art, which are:

1—To equip any pellet production plant with a pellet control chamber.

2—To analyze all the pellets that pass through it.

3—To reject all pellets considered harmful.

4—To put on the market only the pellets considered suitable.

### DISCLOSURE OF INVENTION

This new process is based on inserting in any industrial PELLET production plant and at any point of the plant a technological system called a “control chamber” that can do the job of evaluating the biomass that will form the pellet, detecting the presence of toxic materials deriving from processing scrap and waste with the presence of substances such as lacquers, paints, and sprays, or wood coming from trees contaminated by radioactive, toxic or other environmental factors.

The “control chamber” consists of a series of sensors, optical devices, weighing and control systems that can continuously monitor, analyze and grade all the pellets.

Along with analyzing pellets, the “control chamber” quantifies and classifies the rejects, entering the results in an easy-to-use databank.

The “control chamber” rejects this material from the production cycle, along with providing the aforesaid service.

All of the PELLETS that pass the “control chamber” analysis is, for all intents and purposes, completely analyzed, produced and certified in a constant, continuous line and controlled by computerized safety systems. Thus the pellets are not analyzed by sample as in the traditional plants currently in use.

By means of this process one obtains the absolute certainty that the PELLETS produced from natural wood or various processes are certified.

### BRIEF DESCRIPTION OF DRAWING

(1)—Silo containing pellets not yet analyzed.

(2)—Link between the silo (1) and conveyor belt (3) for the passage of the pellets.

(3)—Conveyor belt for the pellets.

(4)—Taking of pellets from the conveyor belt and sending them to the laboratory (5).

(5)—Laboratory analysis of the pellets.

(6)—Radiation control of the pellets.

(7)—Three-way pellet discharge system.

(8)—Storage silo for pellets that do not pass quality control.

(9)—Storage silo for pellets that pass quality control.

### BEST MODE FOR CARRYING OUT THE INVENTION

The “control chamber” can be installed in any pellet production plant, whether it is already set up or in the installation stage.

The “control chamber” is installed in the place considered most effective according to the plant setup, although installation at the end of the industrial pellet process is to be considered the most suitable for the purpose, i.e. before bagging or packaging.

The “control chamber” continuously analyzes the product, checking certain values that are decisive for the quality and safety of the pellets, especially hydrocarbons, formaldehyde and radioactivity.

The “control chamber” consists of the following elements:
pellet transport system,
inserting of the laboratory in the line,
radioactivity control,
product discharge,
three-way discharge system,
reject silo with weighing cell,
storage silo.

The pellets are analyzed during the processing cycle by means of:
Sample control and/or continuous control of the presence of harmful substances, including hydrocarbons.
Sample control and/or continuous control of the presence of formaldehyde.
Sample control and/or continuous control of the presence of radioactivity.

The “control chamber” is also able, when requested and appropriately set up, to do other analyses on samples from the line regarding the composition of the pellets produced.

The process, analysis and validation of the pellets in the processing cycle is as follows:
The pellets not yet analyzed enter the conveyor belt (3) from a silo (1) by means of any type of link (2);
The path of the conveyor belt gives the system the possibility of collecting (4) and continuously analyzing the product in the laboratory (5);
During the same path all of the product is analyzed by radiation control (6);
The analyzed product ends its passage at the discharge, first passing through a three-way discharge system (7), commanded by the laboratory (5), which sends the pellets to the storage silos (8-9) according to the quality detected;
The certified silo (9) receives the pellets that pass quality control, i.e. ecological pellets, and which can therefore be packaged and put on the market;
The product that does not pass quality control, i.e. non-ecological pellets, is weighed and sent to the silo (8).

All of the control system data are automatically stored without the possibility of tampering and are available online, with alarms for the centralized control station via telephone line or satellite connection, Internet, or similar.

1. Process for the production of solid ecological wood-based fuel called pellets by means of a specific control chamber placed in production plants and pellet bagging that is able to evaluate the biomass that forms the pellet, detecting the presence of toxic materials deriving from processing rejects or from firewood derived from trees contaminated by environmental, radioactive, toxic or other factors, consisting of a pellet transport system, a series of sensors, lights, weighing and control systems that can continuously monitor, analyze and grade all pellets, equipped with a system for the sorting and storage of pellets based on the quality detected that discards product not considered suitable and sends suitable product for packaging; said process makes it possible to reliably certify the ecological quality of the final wood-based product called pellets.

2. Control chamber on the basis of claim 1 characterized by the fact that it can be placed in any industrial pellet production plant.

3. Control chamber on the basis of one of the preceding claims characterized by the fact that it can be placed in any spot in any industrial pellet production plant.

4. Control chamber on the basis of one of the preceding claims characterized by the fact that it analyzes the pellets in the laboratory (5) by means of series of sensors, lights, weighing and control systems that can monitor, analyze, and grade the pellets that go through the control chamber.

5. Control chamber on the basis of one of the preceding claims characterized by the fact that it analyzes the pellets in the laboratory (5) by sample and/or continuously to check for the presence of noxious substances including hydrocarbons.

6. Control chamber on the basis of one of the preceding claims, characterized by the fact that it analyzes the pellets in the laboratory (5) by sample and/or continuously to check for the presence of formaldehyde.

7. Control chamber on the basis of one of the preceding claims characterized by the fact that it analyzes the pellets in the laboratory (5) by sample and/or continuously to check for the presence of radioactivity.

8. Control chamber on the basis of one of the preceding claims characterized by the fact that it analyzes by sample the composition of the pellets.

9. Control chamber on the basis of one of the preceding claims characterized by the fact that it collects the data on the quality and/or the quantity of the rejects with the possibility of entering said data in a specific databank.

10. Control chamber on the basis of one of the preceding claims characterized by a three-way discharge system (7) controlled automatically from the laboratory (5) in which the pellets are sent to silos on the basis of their characteristics.

11. Control chamber on the basis of one of the preceding claims characterized by a three-way discharge system that sends rejected pellets, i.e. those not ecological, to a specific silo (8) equipped with a weighing cell.

12. Control chamber on the basis of one of the preceding claims characterized by a three-way discharge system that sends ecological pellets to a specific silo (9) for storage and/or packaging.

13. Control chamber on the basis of one of the preceding claims characterized by the fact that it certifies the reject pellets and ecological pellets.

14. Control chamber on the basis of one of the preceding claims characterized by the fact that it is equipped with a system for recording all system data, which are stored automatically without the possibility of tampering and are available on a network, with alarms for the centralized control station by means of telephone lines or satellite connection, Internet or similar.
